(19) United States
(12) Patent Application Publication
(10) Pub. No.: US 2025/0045103 A1
(43) Pub. Date: Feb. 6, 2025

(54) OPTIMIZED RESOURCE MANAGEMENT OF CLOUD NATIVE WORKSPACES FOR SHARED PLATFORM

(71) Applicant: Dell Products L.P., Round Rock, TX (US)

(72) Inventors: Shamik Kacker, Austin, TX (US); Bijan Kumar Mohanty, Austin, TX (US); Hung Dinh, Austin, TX (US); Thiagarajan Ramakrishnan, Round Rock, TX (US)

(21) Appl. No.: 18/365,382

(22) Filed: Aug. 4, 2023

(51) Int. Cl. G06F 9/50

(52) U.S. Cl. CPC G06F 9/5016; G06F 9/505

(57) ABSTRACT

One example method includes receiving, by a workspace size predicting engine, a workspace provisioning request including resource requirement information that specifies one or more features that are to be included when a workspace is provisioned. The one or more features include at least a machine learning (ML) model that is to be run in the workspace. The method also includes predicting, by the workspace size predicting engine, the one or more resources for provisioning the workspace that corresponds to the workspace provisioning request.

### FIELD OF THE INVENTION

Embodiments of the present invention generally relate to machine learning (ML) models. More particularly, at least some embodiments of the invention relate to systems, hardware, software, computer-readable media, and methods for deployment of an ML model in a supporting infrastructure.

### BACKGROUND

The data analytics and Machine Learning (ML) subfield of Artificial Intelligence (AI) is growing rapidly across all industries and shifted away from an academic research context to practical and real-world applications. Successfully building and serving ML models in production requires large amounts of data, compute power, and infrastructure. Cloud native architectures are designed to leverage cloud computing techniques to access resources on demand. This type of software architecture makes ML more accessible, flexible, and cost-effective for data practitioners and infrastructure administrators/IT to train and deliver ML capabilities.

Jupyter Notebooks is one of the leading open-source tools for developing, experimenting, and training ML models in the data science community. Jupyter notebooks provides a document specification and UI for editing documents composed of narrative-text, code cells and outputs. Jupyterlab provides an interface for Jupyter Notebooks with interactive computing capabilities. It also has extensions with efforts to run notebooks as data science pipelines and experiment iteratively. JupyterHub provides an application designed for the management of Jupyter Notebooks. RStudio, Airflow, MLFlow, etc. are a few other popular open-source tools that data practitioners use extensively. All these tools/workspaces are available to run on local workstations or deployed as a container on Kubernetes, one of the popular container orchestration frameworks in the industry.

AI/ML workspaces are typically deployed as containers with predefined set of resources like CPU, memory, and storage. Enterprises then have an API gateway to ensure that that the container is accessed securely. While the functional aspects of these offerings do not change much, the nonfunctional requirements/expectations like performance, security and reliability drastically changes at scale. For example, non-functional requirements define on how the system should perform when 1000 users are accessing a workspace simultaneously, millions of jobs are running concurrently at the same time, etc. while continuing to provide a seamless experience to data practitioners.

Software architects and IT administrators are not well equipped and trained to consider different architectural constraints well in advance. If the architects, business units and enterprises fail to adapt their use case to these constraints in advance, ML platforms and workspaces ends up being fragile, and cumbersome to maintain and manage. To understand how to build and scale machine learning tools and platforms, it is important to know how customers are utilizing these deployed tools and then architect cloud native systems, so that they are be optimized, robust, cost-effective, easily maintainable, and effectively manage the resources for the business.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a physical infrastructure of Domino.

FIG. 2 discloses an AWS Sagemaker Notebook.

FIG. 3 discloses Sagemaker resource pricing.

FIG. 4 discloses an architecture to build, train and deploy ML models on Microsoft Azure.

FIG. 5 discloses Vertex AI Workbench Offerings.

FIG. 6 discloses a hypothetical architecture illustrating various problems.

FIG. 7 discloses an end-to-end architecture relating to the example of FIG. 6.

FIG. 8 discloses a JupyterHub landing page.

FIG. 9 discloses an overall architecture according to an example embodiment.

FIG. 10 discloses a table of inputs and associated targets according to an embodiment.

FIG. 11 discloses aspects of a workspace size prediction engine according to an embodiment.

FIG. 12 discloses aspects of training a workspace size prediction engine according to an embodiment.

FIG. 13 discloses aspects of a DNN according to one example embodiment.

FIG. 14 discloses example code for generating a data frame, according to an embodiment.

FIG. 15 discloses example code for encoding non-numerical data of a dataset, according to an embodiment.

FIG. 16 discloses example code for splitting a dataset, according to an embodiment.

FIG. 17 discloses example code for building a DNN according to an embodiment.

FIG. 18 discloses example code for compilation and training of a model according to an embodiment.

FIG. 19 discloses example code for obtaining a prediction by a workspace size prediction engine.

FIG. 20 discloses an example method according to an embodiment.

FIG. 21 discloses an example computing entity configured and operable to perform any of the disclosed methods, processes, and operations.

### DETAILED DESCRIPTION OF SOME EXAMPLE EMBODIMENTS

Embodiments of the present invention generally relate to machine learning (ML) models. More particularly, at least some embodiments of the invention relate to systems, hardware, software, computer-readable media, and methods for deployment of an ML model in a supporting infrastructure.

In one example embodiment, systems and methods are provided that determine configuration and deployment constraints in advance prior to offering them as a service to end users, such as ML models for example. In an embodiment, an AI/ML resource knowledge base is created with information about what model training and serving configurations customers typically from a group utilize, what kinds of data the customer typically uses to build these ML models. In an embodiment, a DNN (Deep Neural Network) may be deployed alongside reinforcement learning techniques, to ensure that workspaces are provisioned with the appropriate resource allocation, thus avoiding disruptions irrespective of where the underlying infrastructure is hosted, such as on-prem or in a cloud environment.

In more detail, an example embodiment may comprise receiving, by a workspace size predicting engine, a workspace provisioning request including resource requirement information that specifies one or more features that are to be included when a workspace is provisioned. The one or more features include at least a machine learning (ML) model that is to be run in the workspace. The method also includes predicting, by the workspace size predicting engine, the one or more resources for provisioning the workspace that corresponds to the workspace provisioning request.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an example embodiment of the invention is that the capacity of an environment to support an ML model workspace may be evaluated in advance before deployment of the ML model. An embodiment may account for ongoing changes to resource needs of an ML model workspace when evaluating an environment for possible placement of the workspace. An embodiment may predict the resource requirements for an ML workspace. An embodiment may identify resource characteristics of a workspace that is being provisioned so that the workspace may be scheduled in an appropriate environment. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment of the Invention

The data science and machine learning community has a wide variety of experience with live systems. Building and, developing and deploying ML systems has become pervasive, fast, and cheap; but maintaining them is difficult and cumbersome. ML systems often interact with the external world, and they are extremely volatile. Running massive sized neural networks and managing massive training datasets to derive meaningful insights would require specialized compute and storage resources. Usually, these external changes and ingestion of data to derive insights and generate alerts occur in real-time, response also should be managed in real-time. To build and deliver these machine learning workspaces resource allocations effectively, it is not unusual for organizations to hire, and groom dedicated machine learning engineers, infrastructure engineers, product application security groups and architects to carefully analyze if the resources allocated well in advance would support the long term needs of the end-users and help IT to forecast if they can accommodate more data practitioners into their ecosystem. Relying on domain experts to alert and make changes is on strategy, but it is fragile for time-sensitive issues and problematic at scale.

Assuming that these organizational and hiring challenges are overcome to hire SMEs across various business units, and entities have stood up AI/ML workspaces with dynamic CPU, memory and storage values, and there exists an appropriate datacenter for data practitioners to pre-process data and build ML models, aspects of some of the current initiatives incorporating cloud native architectural design are provided as comparative examples with one or more embodiments of the invention, and briefly discussed below.

### A.1 Architecture by Domino Data Labs

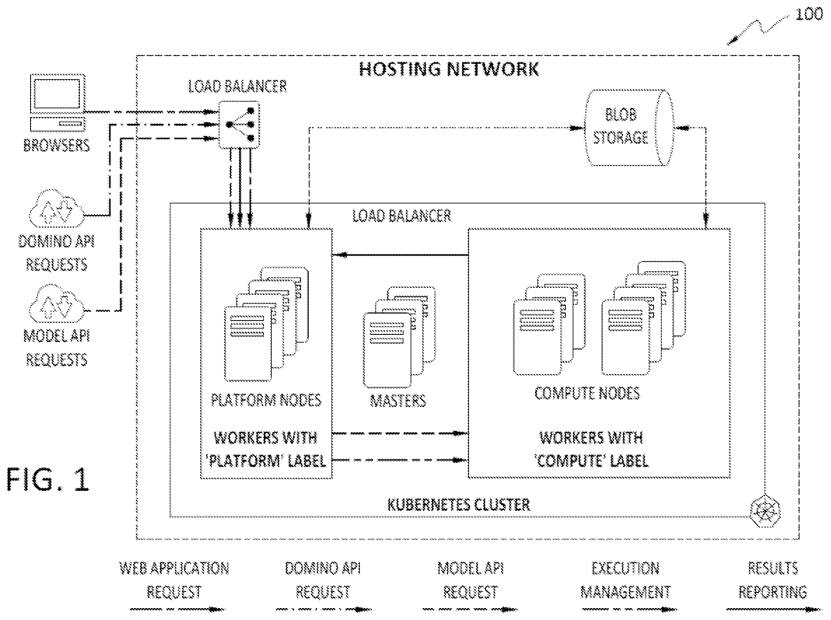

With reference to FIG. 1, a physical infrastructure of Domino Data Labs is indicated at 100. In all workloads in Domino applications run as containerized process orchestrated by Kubernetes. It has two major workloads: Domino Platform—provides user interfaces, API servers, orchestration, metadata and supporting services; and, Domino Compute—data science, engineering and ML workloads are executed. As explained in the Domino Data Lab Admin Guide, outside of the cluster, Domino has a durable blob storage system and a load balancer to regulate connections from users. Users in Domino assign their executions to Hardware Architecture. Number of resources like cores, cores limit, memory, memory limit, number of GPUs are assigned by Domino based on the hardware tier that the user chose. Notably, no expertise is provided on how to provision these resources across multiple data centers.

### A.2 Reference Architecture by Amazon Sagemaker

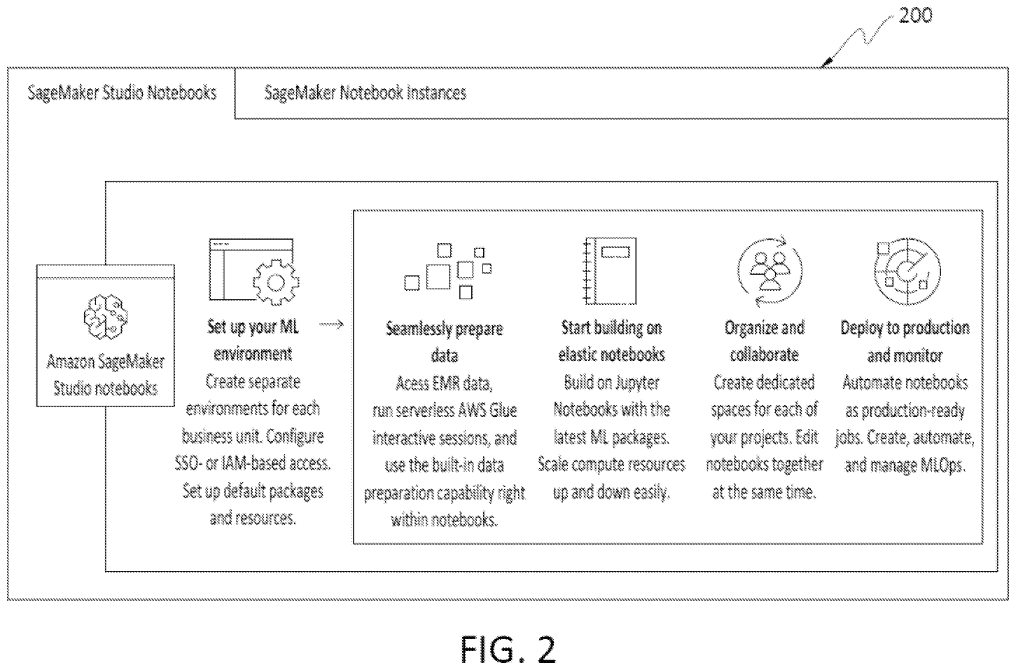

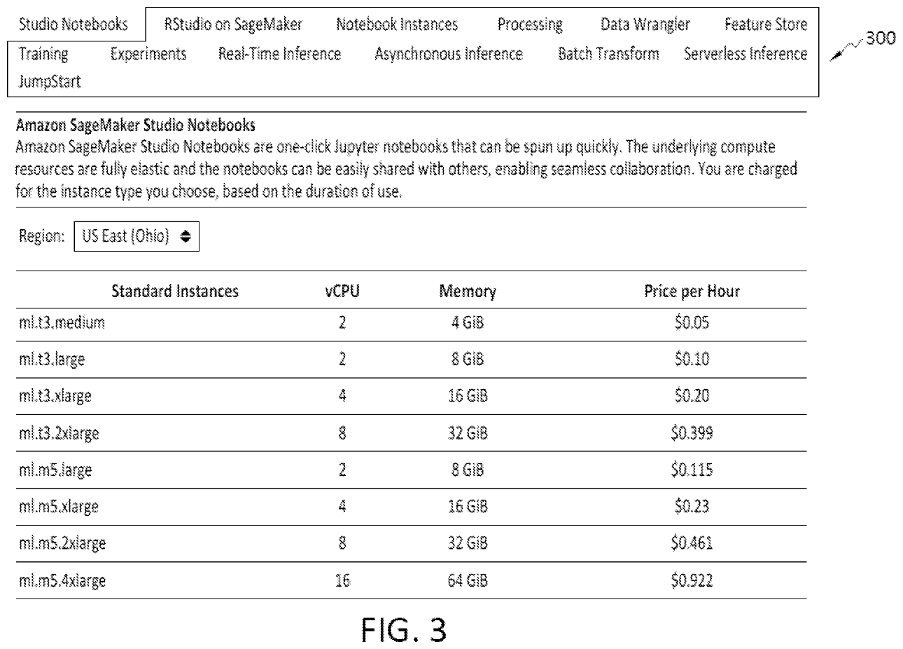

With reference now to FIG. 2, an AWS (Amazon Web Services) Sagemaker Studio Notebook is denoted at 200. Cloud providers such as AWS offer Sagemaker notebooks. These fully managed notebooks are used for exploring data, training, and deploying (ML) models on AWS cloud. As shown in FIG. 3, which discloses Sagemaker resource pricing information, AWS Sagemaker users are offered a selection 300 of compute and storage resources that would be necessary to handle their AI/ML workloads. As shown, users are given the option to pick the right region to deploy their instance. Notably, however, the users are not provided with any guidance as to whether that region is appropriate or not for their particular use case.

### A.3 Reference Architecture by AzureML

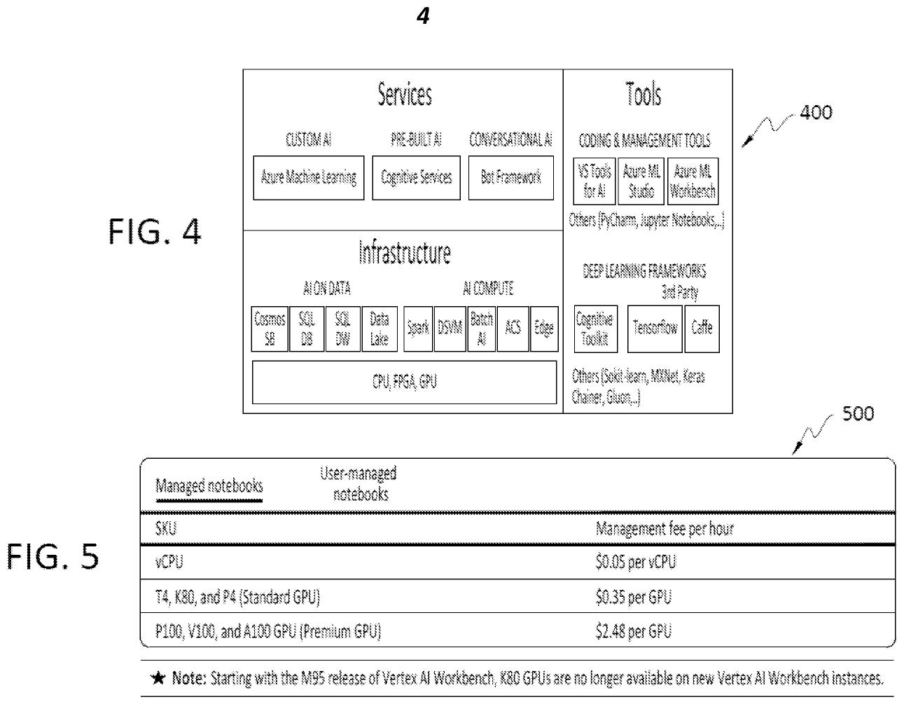

With reference to FIGS. 4, there is shown an architecture 400 to build, train and deploy ML models on Microsoft Azure. Microsoft Azure ML platform is a fully managed platform to build, deploy and manage models at scale. As summarized in the AzureML Documentation, Jupyter notebooks and other AI/ML workspaces are offered with pre-configured resources in their offerings. The AzureML workspace is the Microsoft top-level resource for all machine learning activities, and provides their end users a centralized place to view and manage the artifacts that are generated while using their product. Similar to AWS, Azure also provides an option to select a region where users would have their workspace spun up on.

### A.4 Reference Architecture by Google Cloud

With reference to FIG. 5, there is shown Vertex AI Workbench Offerings 500. Particularly, FIG. 5 captures Vertex AI Workbench Management fees in addition to infrastructure usage. Vertex AI Managed notebooks with pre-configured compute and storage resources are charged at the same rate as a customer pays for compute engine and cloud storage offerings.

### B. Example Problems that May be Addressed by an Embodiment of the Invention

Data scientists and architects need to decide on what is the best possible approach to fetch data, build models and run inference on top of the pre-built model. Data scientists must be an expert in Containers, Kubernetes, Data Security, Endpoints, Scaling, Persistent Volumes, GPUs DevOps, Programming in new languages, and tools, for example. Some approaches may help data practitioners to dynamically allocate the right set of resources for their AI/ML workspaces deployed on cloud-native infrastructures like Kubernetes.

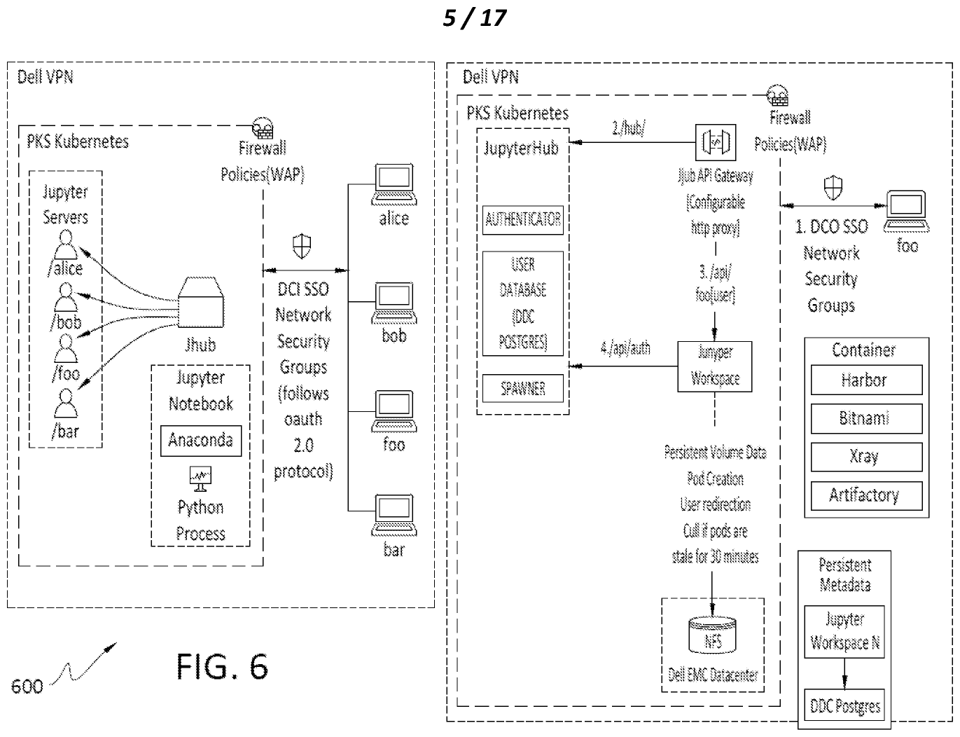

However, as data practitioners aspire to operate at scale to improve their model accuracy and have recurrent feedback loops back and forth various components in the data platform stack, the resource constraints need to be elastic with minimal disruption from IT administrators. FIG. 6 is illustrative of these problems, as it discloses an architecture 600 that is used for deploying AI/ML applications as containers on top of Kubernetes, but which lacks features such as those just noted.

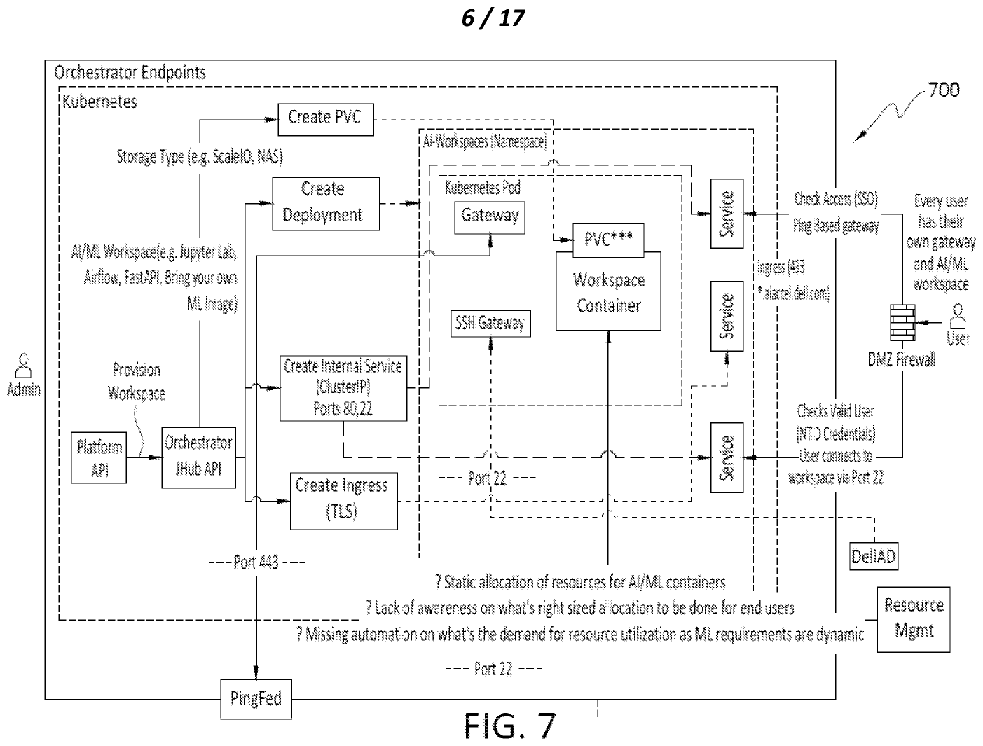

With reference now to FIG. 7, there is shown an end-to-end architecture 700 in which a set of Kubernetes APIs are deployed on top of clusters. As captured in FIG. 7, container images are securely fetched from a registry such as Harbor and deployed using CI/CD solutions such as Gitlab. The environment variables necessary to deploy these applications are fetched from vault during runtime. If there are any open-source packages that need to be leveraged for running certain AI/ML workloads, they are fetched from a JFrog artifactory. The data currently stored in AI/ML workspaces are accessible across multiple clusters via network attached storage component (NFS). Some of the artifacts relevant to ML also are stored and retrieved from ECS object store.

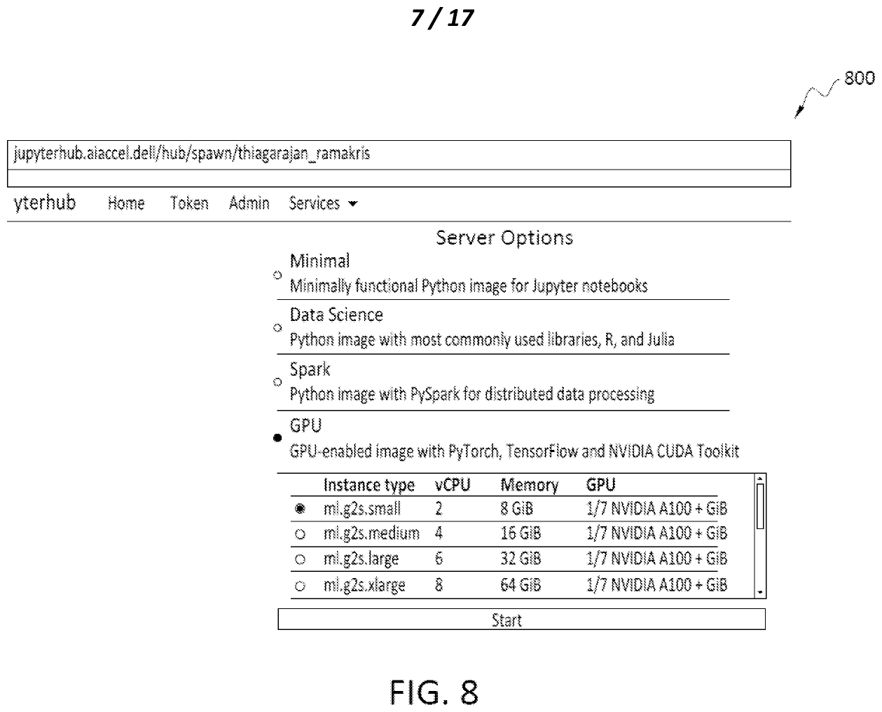

Turning next to FIG. 8, there is shown a sample landing page 800 of Jupyter Notebooks provisioned within a JupyterHub instance on a certain datacenter. However, no provision is made for making a decision with respect to selecting the right infrastructure for their personalized use-case.

As illustrated in FIGS. 1 through 8, there are at least three fundamental problems with the approaches shown in those Figures, any one or more of which may be addressed by one or more example embodiments of the invention. One of such problems is the static allocation of resources, in which AI/ML workspaces are provisioned with CPU, GPU, memory, and storage values that are static. Because these resource allocations are static, they fail to factor that the resource requirements (computing, memory, IO, etc.) vary from workspace to workspace depending upon the type of ML algorithms, data set size, and complexity of the requirements. Another problem is that these approaches require manual intervention for scaling. It is not unusual for companies to hire dedicated IT administrators to bump or down the resources based on utilization to optimize the cost of their business, which keeping user experience consistent. Such manual approaches are simply unable timely and accurately to account for ongoing changes in the AI/ML workspaces, or for changes in the environments where those AI/ML workspaces are placed. A human is unable to predict, or react to, such changes in a timely and technically adequate manner. As well, these manual approaches are prone to the introduction of human errors. A final problem is that such approaches fail to provide process automation for optimizing resource utilization. Choosing the appropriate set of pre-configure resources is challenging, and system administrators are not able to keep up with the demand and utilization of resources for a single team of data practitioners, much less for multiple, larger, teams.

### C. Detailed Description of an Example Embodiment of the Invention

### C.1 Overview

An example embodiment of the invention comprises a method for calculating the resource requirements (compute, memory, storage, etc.) of a workspace based on historical resource utilization of similar workspaces with similar features using advanced Machine Learning. The method may leverage the historical utilization data of each workspace along with the features and requirements of each workspace such as type of algorithm, dataset size, number of data dimension and class of learning and the hosted environment behavior such as infrastructure metrics like CPU, memory, and storage utilization as captured in the logging systems. The utilization data with a timestamp captures the load, volume, seasonality and are an excellent training indicator of the future resource utilization. By utilizing sophisticated Machine Learning algorithms, for example a neural network based multi-target regression algorithm, the method can predict the size of each resource component for that workspace. Infrastructure orchestration tools like Kubernetes can then use these resource sizes while provisioning the initial workspace as well as new instances of containers/pods/VMs for auto-scaling. This capability will enable intelligent resource sizing at the time of provisioning in an elastic auto-scaling environment.

### C.2 Example Architecture According to One Embodiment of the Invention

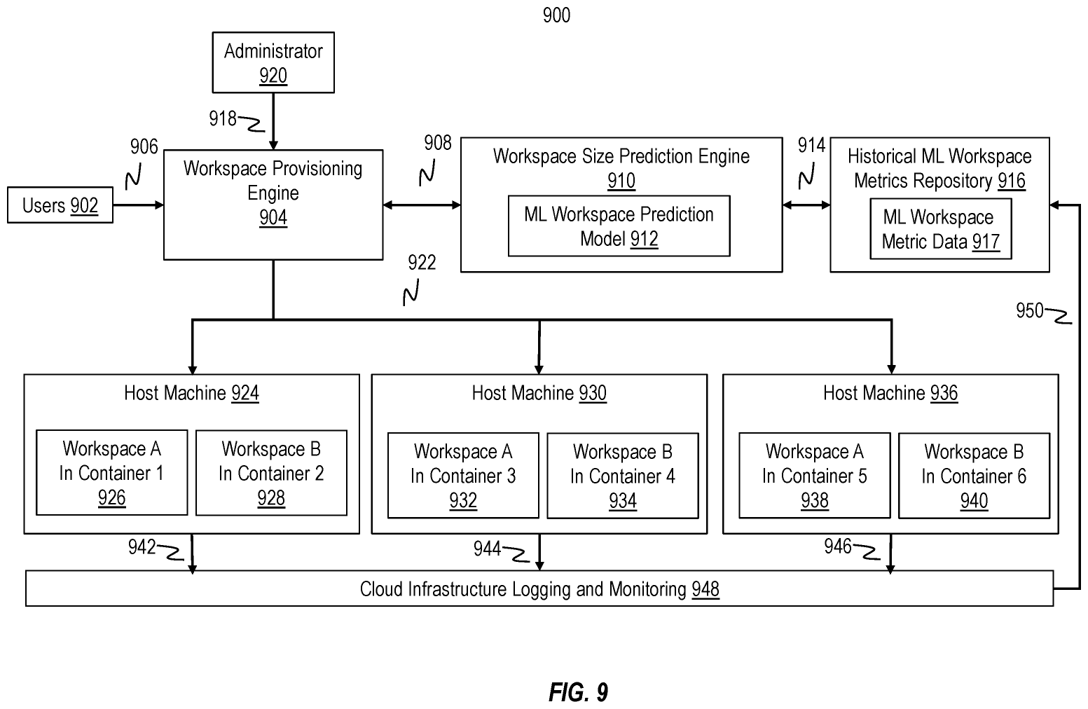

With attention now to FIG. 9, an example architecture, and associated methods and operations, according to one embodiment of the invention are denoted at 900. As shown, users 902 may access a workspace provisioning engine (WPE) 904, which may comprise an element of a platform for provisioning ML workspaces in which an ML model or ML algorithm is to be run. Note that as used herein an ‘ML model’ or ‘model,’ may comprise, among other things, an ‘ML algorithm’ that is executable to obtain various results.

To access the WPE 904, the users 902 may send a request 906 to the WPE 904, such as by calling an API or sending the details of the required workspace in a JSON format. The request 906 may include, for example, information that specifies desired features of the workspace such as the type of ML algorithm to be run in the workspace, the size of a training dataset for the ML algorithm, the number of users working on the workspace, and the type of use, such as production or non-production, of the required workspace. In an embodiment, the request 906 may ultimately result in the creation and provisioning of a new workspace, or modification of an existing workspace in terms of its provisioning.

This information in the request 906 may be passed 908 to an ML workspace size prediction engine (WSPE) 910, which may comprise a ML workspace prediction model or algorithm 912 that predicts, based on the information in the request 906, the number of containers, compute, and storage size of each container. The ML workspace prediction model 912 of the WSPE 910 may be trained using training data that is received 914 from an historical ML workspace metrics repository (WMR) 916.

Upon being approved 918 by a platform administrator 920, the prediction from the WSPE 910 may be used by the WPE 904 to provision 922 an optimal workspace size corresponding to the request 906. In an embodiment, the WPE 904 may use Kubernetes functions for provisioning the number of containers with the size as predicted by the WSPE 910. For example, the WPE 904 may provision a host machine 924 having a workspace A in a container 1 as show at 926 and having a workspace B in a container 2 as shown at 928, provision a host machine 930 having a workspace A in a container 3 as show at 932 and having a workspace B in a container 4 as shown at 934, and provision a host machine 936 having a workspace A in a container 5 as show at 938 and having a workspace B in a container 6 as shown at 940.

Information 942, 944, and 946 about the resource requirements (compute, memory, storage, etc.) of the workspaces on each of the host machines 924, 930, and 936 is provided to a cloud infrastructure logging and monitoring component 948. The resource requirement information may then be provided 950 to the WMR 916 to be stored as historical ML workspace metrics data 917 for use in further training of the ML workspace prediction model 912. It will be noted that the WMR 916 may also receive historical ML workspace metrics data 917 from other sources besides those shown in FIG. 9. Thus, the ML workspace prediction model 912 may be trained by the historical ML workspace metrics data 917 included in the WMR 916 that is received from the other sources in addition to the historical ML workspace metrics data 917 received from the workspaces shown in FIG. 9.

Briefly then, the example architecture 900 according to one embodiment of the invention may be implemented to comprise various components. These components may include the WPE 904, the WSPE 910, and the WMR 916. These components, which may each comprise a respective ML model to carry out their respective functions, are considered in turn below.

### C.2.1 Aspects of an Example WPE

In an embodiment, the WPE 904 comprises a workflow that receives the workspace requirement features requested 906 by the users 902 of the platform, and utilizes the WSPE 910 to get the optimal value(s) of the workspace(s), such as the number of containers, and the processing and memory needs of each container. After the WPE 904 determines the size of the workspace(s) needed, the platform administrator 920 may approve 918 the workspace size, although such approval is not required in every case. Upon approval 918 of the workspace size, the WPE 904 components may call the necessary APIs (application program interface) of Kubernetes, or another orchestration platform capable of automated deployment, scaling, and management of containerized applications for the provisioning 922 of the necessary workspaces, such as workspaces shown at 926, 928, 932, 934, 938, and 940, in the shared platform.

### C.2.2 Aspects of an Example WMR

In an embodiment, the historical ML workspace metrics data 917, stored in the WMR 916, may be the best indicator for predicting, with high accuracy, what would be the most optimal workspace size for a future ML workspace. In an embodiment, the WMR 916 may comprise a data repository that harvests workspace infrastructure metrics data from the cloud infrastructure logging and monitoring component 948 and filters the unnecessary variables out of that data.

In an embodiment, data engineering and data pre-processing may be done early to enable an understanding of the features and the data elements that will be influencing the predictions for infrastructure size of the workspace. This analysis may include, for example, multivariate plots and correlation heatmap to identify the significance of each feature in the dataset so that un-important data elements are filtered. This filtering may be performed at/by the WMR 916. The filtering may help to reduce the dimensionality and complexity of the ML workspace prediction model 912, such as may be included in the WSPE 910 for example, thus improving the accuracy and performance of the ML workspace prediction model 912.

In an embodiment, the WMR 916 the ML workspace metrics data 917 may include, but is not limited to, the type of ML algorithm to be used in the workspace, workspace domain, size of training data, number of users using the system, type of use such as production or non-production, as well as the average compute, storage and IO utilization of the workspace, along with the response/target variables such as, but not limited to, the number of containers and compute and memory size of each container. As discussed above, the ML workspace metrics data 917 may be supplied 914 as training data to the WSPE 910, as discussed in more detail below.

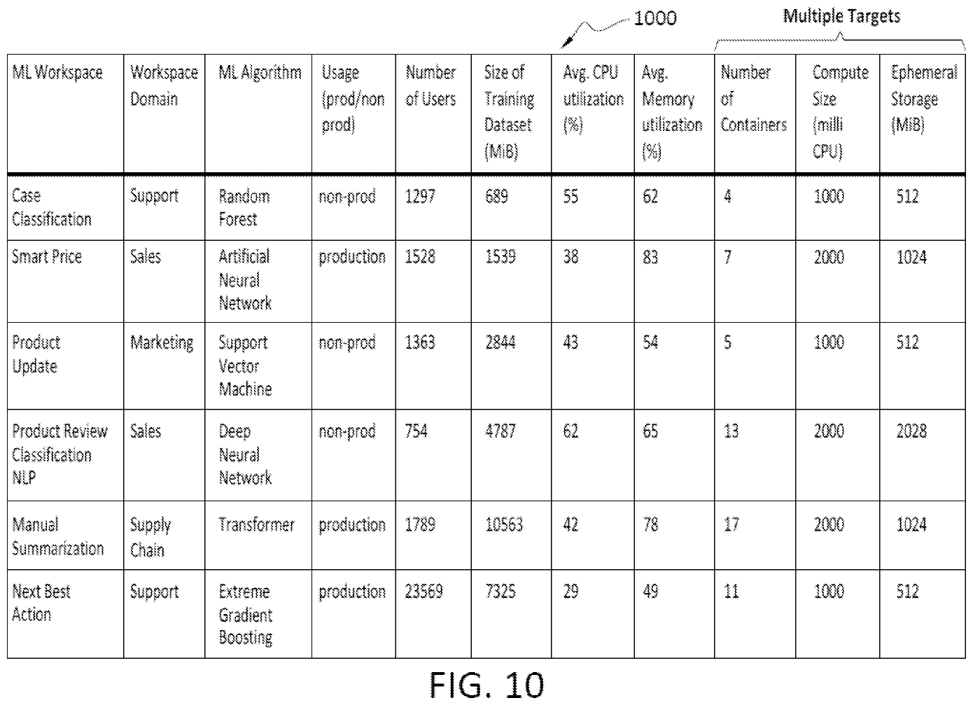

With continued reference to FIG. 9, and directing attention now to FIG. 10 as well, a table 1000 is disclosed that comprises example data elements that may be stored in the WMR 916 as part of the ML workspace metrics data 917 and used for training the ML workspace prediction model 912 in the WSPE 910. It is noted, with regard to the example of table 1000, that the table 1000 comprises an example subset of attributes, not all of which may be required to train the ML workspace prediction model 912. In an embodiment, the column data ‘Avg. CPU utilization (%)’ and the ‘Avg. Memory Utilization (%)’ may not need to be used as features for training the ML workspace prediction model 912. As also indicated in FIG. 10, the table 1000 comprises example data for workspace size estimation multi-target regression algorithm training. In this example, the targets to be predicted by the ML workspace prediction model 912 may comprise ‘Number of Containers,’ ‘Composite Size (milli CPU),’ and ‘Ephemeral Storage (MiB).’ Additional or alternative targets may be specified in other embodiments.

### C.2.3 Aspects of an Example WSPE

As noted earlier herein, a WSPE 910 according to one embodiment of the invention may comprise a dynamic, and predictive approach for calculating the resource requirements, such as compute, memory, and storage, for example, required by one or more workspaces. Such calculation may be performed using the ML workspace prediction model 912 based on historical resource utilization of similar workspaces with similar features, that is the historical ML workspace metrics data 917.

In more detail, in order to make such predictions for a workspace instance resource sizing, an embodiment of the invention may employ timestamped historical utilization data of each workspace, along with the features and requirements of each workspace, which may include the type of algorithm, dataset size, number of data dimension and class of learning. The hosted environment behavior may also be employed as a basis for making predictions as to workspace instance resource sizing and provisioning. Such hosted environment behavior, which may be captured by a logging system, may include, for example, infrastructure metrics such as CPU (central processing unit), memory, and storage utilization.

The timestamped historical utilization data may comprise, for example, the load, volume, and seasonality of the resource utilization, and are a good training indicator of the future resource utilization. By utilizing an ML algorithm comprising a neural network based multi-target regression algorithm, an embodiment of the invention may predict the size of each resource component for that workspace. Infrastructure orchestration tools such as Kubernetes, ECS, EKS, and PKS for example, may then use these predicted resource sizes as a basis for provisioning the initial workspace, as well as for creating new instances of containers/pods/VMs for auto-scaling. This capability may enable intelligent resource sizing at the time of workspace provisioning in an elastic auto-scaling environment that may scale resources up or down to meet changing workspace requirements.

Thus, an embodiment of the WSPE 910 may predict, with relatively high accuracy, the optimal size of a new ML workspace based on a variety of features or attributes such as those shown in FIG. 10 that are used in the training data set. Based on the complexity and dimensionality of the issue resolution data in the enterprise that requires the new workspace, an embodiment of the ML workspace prediction model 912 of the WSPE 910 may comprise a deep neural network based multi-target regressor, capable of predicting various target variables for a workspace. Such target variables comprise, but are not limited to, [1] the number of containers, [2] compute or processing requirements for the workspace, and [3] ephemeral storage/memory of the containers. In an embodiment, the WSPE 910 may implement a supervised learning approach and a multi-target or multi-output regression-based machine learning algorithm to predict the number of containers and the size of various resources of the workspace instance including compute and ephemeral storage.

To facilitate generation of the predictions, historical utilization metrics of the workspace and their hosting infrastructure, such as a container and host server for example, may be harvested from monitoring and logging systems in the environment where the workspace is provided, such as a cloud environment or on-prem environment for example. The historical metrics data 917 will be used to train the ML workspace prediction model 912 in the WSPE 910.

Typically, regression algorithms use one or more independent variables and predict a single dependent variable. As an embodiment of the invention may involve multiple different resources in the host infrastructure, such as compute, storage, and the number of containers, the model of the WSPE 910 may predict multiple different outputs, that is, the WSPE 910 may comprise a multi-target/output model. In multi-target regression, the outputs may be dependent on the input, and also dependent upon each other. For example, the number of containers or memory utilization may sometimes be dependent upon the CPU, and vice versa. This means that often the outputs are not independent of each other and may require a model that predicts both outputs together and each output contingent upon the other outputs. Building separate models, one for each output and then using the outputs of all models to predict all resource sizes may present implementation difficulties and performance concerns, however. Thus, an embodiment of the invention employs the specific approach of multi-target regression.

There are various approaches and algorithms to achieve multi-target regression, and such algorithms may, or may not, be employed in an embodiment of the invention. Some algorithms have built-in support for multi-target outputs, while others do not. Algorithms that do not support multi-target regression may be used as a wrapper to achieve multi-output support. For example, regression algorithms such as Linear Regressor, KNN Regressor, Random Forest Regressor support multi-target predictions natively, whereas Support Vector Regressor or Gradient Boosting Regressors do not support multi-target predictions and need to be used in conjunction with a wrapper function such as the MultiOutputRegressor available in the multioutput package of SKLearn library. An instance of these algorithms may be fed to the MultiOutputRegressor function to create a model that is able to predict multiple output values.

### C.2.3.1 Detailed Discussion of Example Embodiment of a WSPE

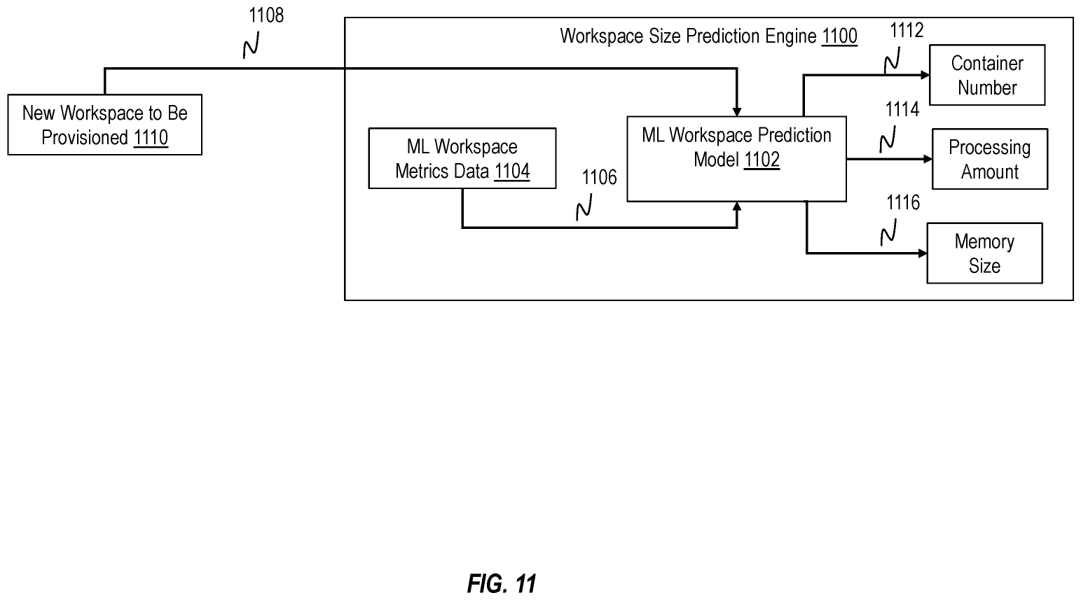

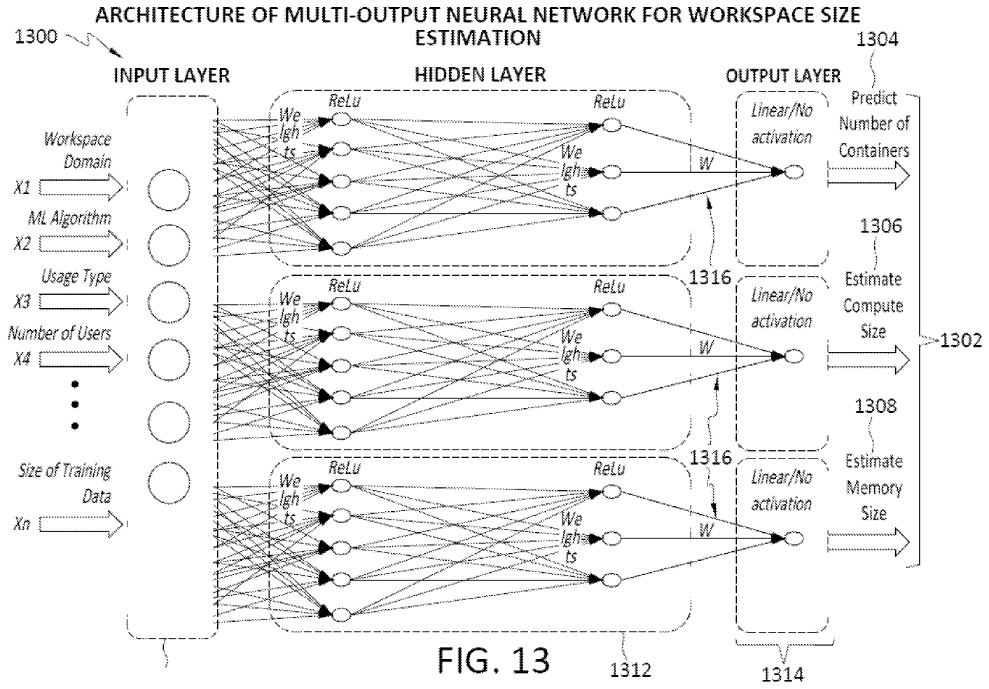

With attention now to FIG. 11, further details are provided concerning a WSPE 1100 according to one embodiment of the invention. As shown, the WSPE 1100, which may correspond to the WSPE 910, may comprise an ML workspace prediction model 1102, which may correspond to the ML workspace prediction model 912 for example, that uses multi-target regression to generate predictions of target variable values for one or more parameters of a workspace. Thus, in an embodiment, the ML workspace prediction model 1102 may comprise a DNN (deep neural network)-based multi-output regressor. Further details of such a DNN according to one embodiment of the invention are provided below in the discussion of FIG. 13.

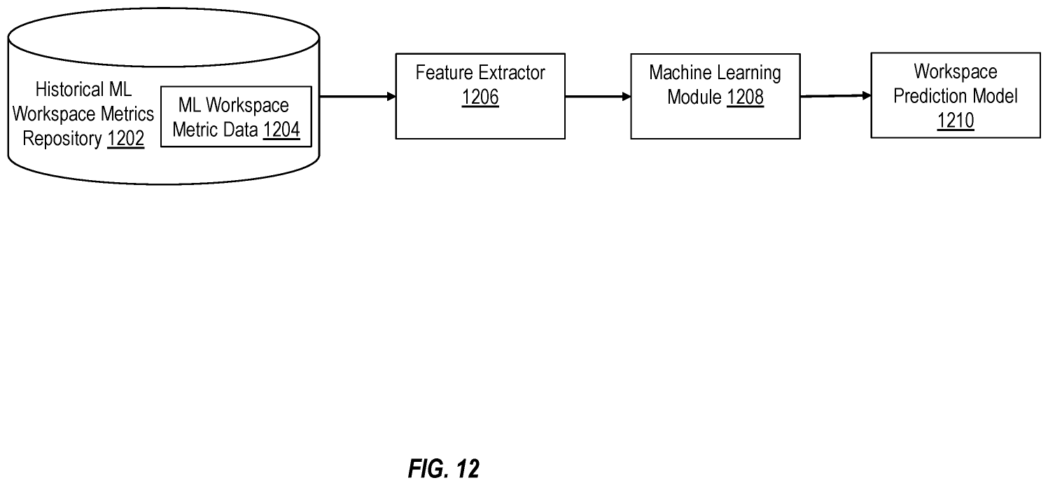

With continued attention to FIG. 11, various inputs may be provided to the ML workspace prediction model 1102. One such input to the ML workspace prediction model 1102 may comprise ML workspace metrics data 1104, which may correspond to the ML workspace metrics data 917 that includes historical data/metadata about resource consumption in other workspaces. In an embodiment, the ML workspace metrics data 1104 may be used to train 1106 the ML workspace prediction model 1102 as described in relation to FIG. 12.

FIG. 12 illustrates an embodiment of an example ML network 1200 that is configured to use ML workspace metrics data to train a ML workspace prediction model. As illustrated, the ML network 1200 includes a historical ML workspace metrics repository 1202 that may correspond to the historical ML workspace metrics repository 916 and that has stored thereon ML workspace metrics data 1204, which may correspond to the other ML workspace metrics data previously described. The ML workspace metrics data 1204 is processed by a feature extractor 1206 configured to extract features from the ML workspace metrics data 1204. The features extracted by the feature extractor 1206 include one or more of, but are not limited to, the features or attributes shown in FIG. 10. The extracted features are then used by the machine-learning module 1208 to train a workspace prediction model 1210, which may correspond to any of the workspace prediction models previously described.

Returning to FIG. 11, the trained workspace prediction model 1102 may then be used to make predictions as to the size, and resources, of a workspace needed by a user. Thus, a user may specify information 1108, such as workspace parameters, for a new workspace to be provisioned 1110. As noted elsewhere herein, the parameters may be provided as part of a request by a user that a workspace size be predicted for an ML model that the user wishes to deploy. The workspace prediction model 1102 may then use the information 1108 provided by the user to make predictions as to various target variables of the workspace requested by the user. Thus, such predictions may comprise, by way of illustration but not limitation, a prediction 1112 as to the number of containers needed for the workspace, a prediction 1114 as to an amount of processing power, or CPU, needed for the workspace, and a prediction 1116 as to an amount of memory needed for the workspace.

Due to the complexity and dimensionality of the data as well as the nature of multi-target prediction and estimation at the same time, an example embodiment comprises a DNN that has three parallel branches, all act as regressors for predicting, respectively, the number of containers, the estimated CPU, and estimated memory size of each container.

Turning now to FIG. 13, a DNN according to one example embodiment is denoted generally at 1300. The DNN 1300 may be implemented in, and perform the functions of, an ML model, such as the workspace prediction model 1102 discussed above. In an embodiment, the DNN 1300 may comprise a multi-output neural net comprises three parallel branches of network for three types of outputs 1302, such as a prediction 1304 as to the number of containers needed for the workspace, a prediction 1306 as to an amount of processing power, or CPU, needed for the workspace, and a prediction 1308 as to an amount of memory needed for the workspace.

By taking the same set of input variables through a single input layer 1310 the DNN 1300 provides parallel regressors, three in this example, for generating multi-output predictions. The example DNN 1300 comprises, in addition to the input layer 1310, one or more hidden layers 1312, two in this example, and an output layer 1314. In its implementation as a multi-output neural network, the DNN 1300 may comprise three separate branches 1316 of network, namely, two hidden layers 1312 and one output layer 1314, that all connect to the same input layer 1310.

In the example DNN 1300, the input layer 1310 comprises a number of neurons that matches the number of input/independent variables. Further, the hidden layer 1312 comprises two layers in the example architecture of the DNN 1300 and the neuron on each of the two layers in the hidden layer 1312 depends upon the number of neurons in the input layer 1310. The output layer 1314 for each branch 1316 may contain a different number of neurons, depending on the type of output used. But in the example of FIG. 13, all branches 1316 use just one neuron in each branch 1316. Since all the branches 1316 are configured as regressor branches, there will be one neuron for the output layer 1314, but linear or no activation function. The neurons in the hidden layers 1312 may use ReLu (rectified linear unit) activation for all three branches 1316.

### C.2.3.2 Aspects of an Example Method for Implementing and Using a WSPE

### C.2.3.2.1 Data Pre-Processing

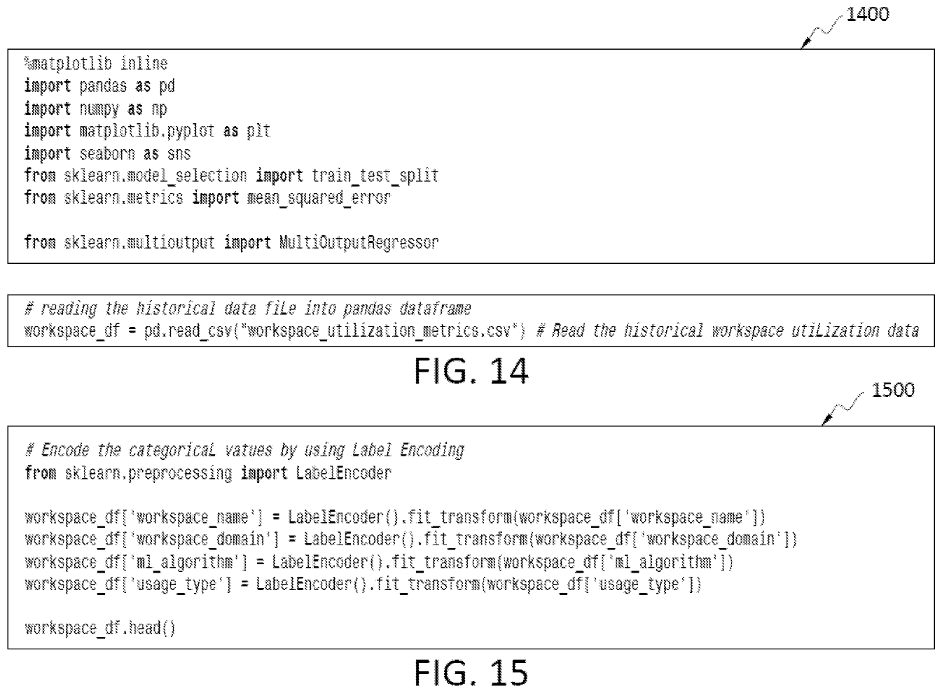

A method according to one embodiment may begin with data pre-processing. For example, a dataset of the of the historical workspace utilization data file may be read, and a Pandas data frame generated. The data frame may contain all the columns including independent variables, as well as both the dependent/target variable columns, namely, number of containers, compute requirements, and memory size. The initial operation may be to conduct pre-processing of data to handle any null or missing values in the columns. In an embodiment, null/missing values in numerical columns may be replaced by the median value of the values in that column. After performing an initial data analysis by creating univariate and bivariate plots of these columns, the importance and influence of each column may be understood. Columns that have no role or influence on the actual prediction, that is, on the target variables of [1] number of containers, [2] compute requirements, and [3] memory size, may be dropped. FIG. 14 discloses example code 1400 for generating a data frame such as that just described.

### C.2.3.2.2 Encoding

As ML models according to one or more embodiments of the invention may operate using numerical values, textual categorical values in the columns (see FIG. 10) of a dataset may be encoded. For example, categorical (textual) values such as ‘workspace domain,’ ‘ML algorithm,’ and ‘usage,’ may be encoded as numerical values. In an embodiment, the encoding may be performed using code 1500 disclosed in FIG. 15, such as LabelEncoder from ScikitLearn library, which is shown in FIG. 15.

### C.2.3.2.3 Dataset Splitting

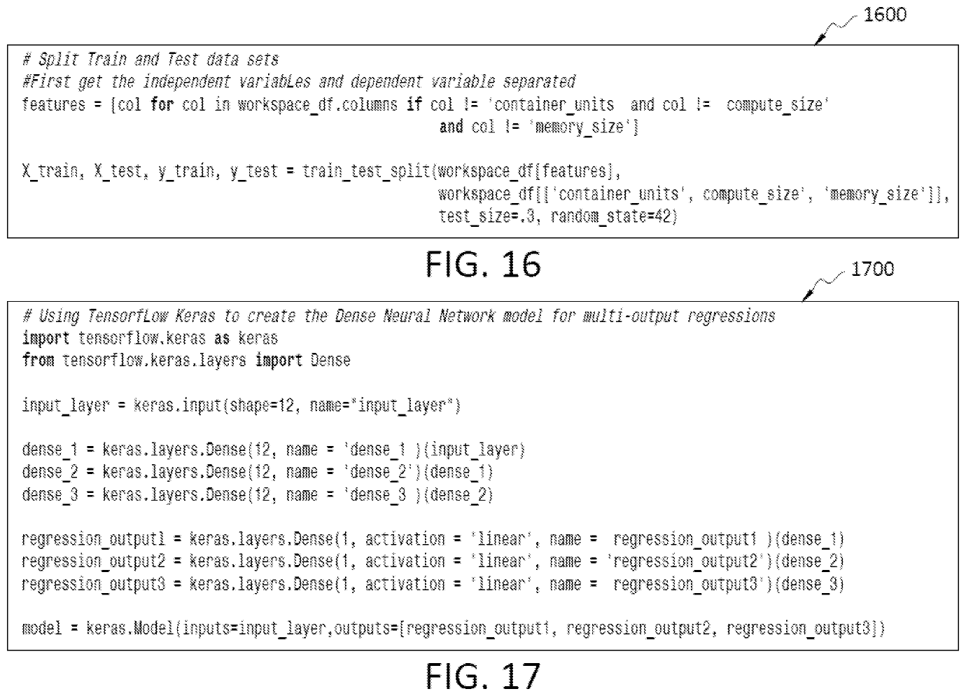

In an embodiment, a dataset to be used in connection with the generation of predictions as to parameters of a workspace may be split into a training dataset, and a testing dataset, using a train_test_split function of ScikitLearn library with 70%-30% split, as shown in the example code 1600 of FIG. 16. Since an embodiment may implement multi-target predictions (see table 1000 for example targets), it is useful to separate both the target variables from the dataset.

### C.2.3.2.4 NN (Neural Network) Model Creation

In an embodiment, a model, such as the workspace prediction model 1102 for example, may comprise a multi-layer, multi-output capable, DNN. In an embodiment, this DNN may be built using the Keras functional model, as separate branches may be created and added to the functional model. In an embodiment, three separate dense layers are added to the input layer, with each network being capable of predicting a different respective target, such as parameters of a workspace for example. Example code to build an embodiment of the DNN is indicated at 1700 in FIG. 17.

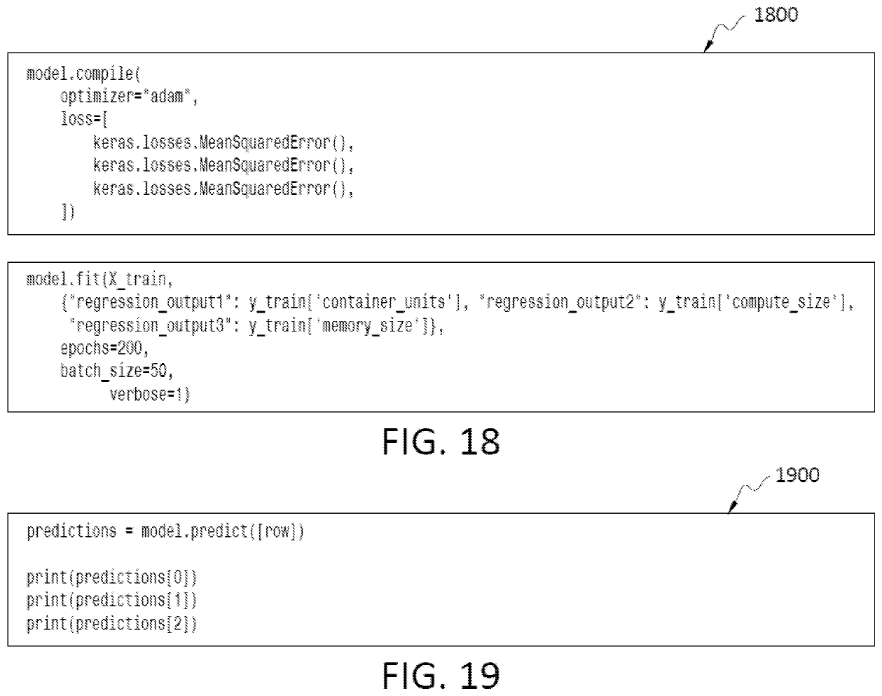

A model according to one embodiment may use “adam” as the optimizer and the “binary_crossentropy” as the loss function for both binary classification branches, that is, a branch that indicates either there is a security issue or not, and another branch that indicates either there is a performance issue or not. In an embodiment, the model may be trained with the training independent variables data X_train, and the target variables may be passed for each path, or classification. Example code for the model compile and training is denoted at 1800 in FIG. 18.

### C.2.3.2.5 Prediction Generation

Once the model is trained, the model may be directed to predict target values by passing independent variable values to the predict( ) of the model. For example, the model may be directed to predict, based on various inputs received by the model, various parameters of a workspace such as, for example, compute, number of containers, and memory. Example code for prediction generation is denoted at 1900 in FIG. 19.

### D. Further Discussion

As apparent from this disclosure, example embodiments disclosed herein may possess various useful aspects and features. Some examples of these follow.

For example, an embodiment disclosed herein may formulate programmatically, and with a high degree of accuracy, predict the actual resource size, such as compute, ephemeral storage, and containers, of an ML workspace hosting instance, such as a container, pod, or VM (virtual machine) for example, by leveraging a sophisticated machine learning algorithm, and training the algorithm using the historical utilization data of similar workspaces with similar features and requirements.

An embodiment disclosed herein may implement a multi-target Regression ML model that is trained using multi-dimensional features of the ML workspace's historical resource utilization data, the model will predict the size of the resources factoring the seasonality, load, and volume of the transactions and features including type of algorithms, dataset size number of dimensions etc.

A further embodiment disclosed herein enables dynamic resource sizing in auto-scaling as Auto-scaling feature of the cloud orchestration tools will utilize the predicted resource sizes while provisioning the new instances for the ML workspace cluster, instead of using the static, hard-coded value in the configuration file, thus enabling optimized infrastructure utilization.

### E. Example Methods

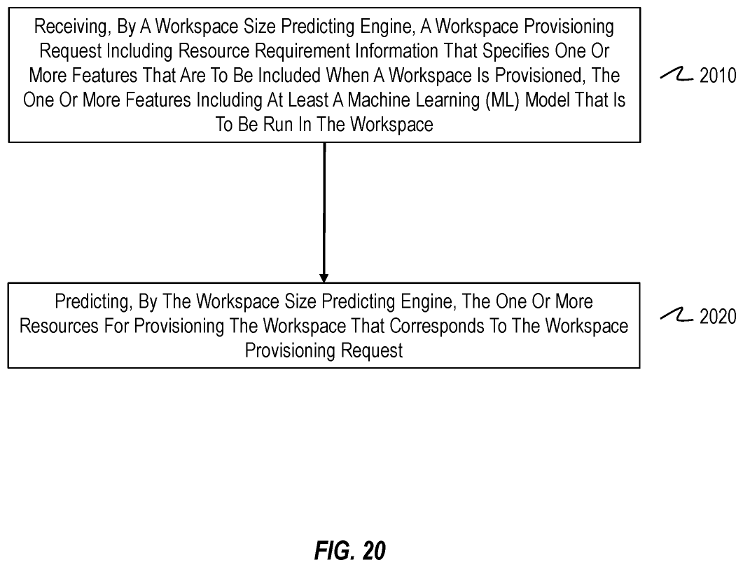

It is noted with respect to the disclosed methods, including the example method of FIG. 20, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 20, a method according to one example embodiment is denoted generally at 2000. The method 2000 includes receiving, by a workspace size predicting engine, a workspace provisioning request including resource requirement information that specifies one or more features that are to be included when a workspace is provisioned, the one or more features including at least a machine learning (ML) model that is to be run in the workspace (2010). For example, as previously described the WSPE 910 receives the workspace provisioning request 906 for provisioning a workspace such as those shown at 926, 928, 932, 934, 938, and 940. The workspace provisioning request 906 includes at least the ML model that will be used in provisioned workspace. In some embodiments, the workspace provisioning request may also include one or more of a size of a training dataset for the ML model run in the workspace, a number of users working on the workspace, and a type of use of the workspace.

The method 2000 includes predicting, by the workspace size predicting engine, one or more resources for provisioning the workspace that corresponds to the workspace provisioning request (2020). For example, as previously described the WSPE 910 predicts the one or more resources needed to provision the workspace. The one or more resources can be a number of containers, and a respective amount of memory and processing capability for each of the containers. The WSPE 910 can include the ML workspace prediction model 912, which can be implemented as a deep neural network (DNN)-based multi-output regressor that uses multi-target regression to predict the size of the workspace.

### F. Further Example Embodiments

Following are some further example embodiments of the invention. These are presented only by way of example and are not intended to limit the scope of the invention in any way.

Embodiment 1. A method, comprising: receiving, by a workspace size predicting engine, a workspace provisioning request including resource requirement information that specifies one or more features that are to be included when a workspace is provisioned, the one or more features including at least a machine learning (ML) model that is to be run in the workspace; and predicting, by the workspace size predicting engine, one or more resources for provisioning the workspace that corresponds to the workspace provisioning request.

Embodiment 2. The method as recited in any preceding embodiment, wherein the one or more resources for provisioning the workspace comprise a number of containers, and a respective amount of memory and processing capability for each of the containers.

Embodiment 3. The method as recited in any preceding embodiment, wherein the workspace size prediction engine provides the one or more resources for provisioning the workspace to a workspace provisioning engine that provisions the workspace using the one or more resources for provisioning the workspace.

Embodiment 4. The method as recited in any preceding embodiment, wherein the workspace size prediction engine comprises a deep neural network (DNN)-based multi-output regressor that uses multi-target regression to predict the one or more resources for provisioning the workspace.

Embodiment 5. The method as recited in embodiment 4, wherein the targets of the multi-target regression are a number of containers, and a respective amount of memory and processing capability for each of the containers.

Embodiment 6. The method as recited in any preceding embodiment, wherein the workspace size prediction engine is trained based in part using historical workspace resource metrics data.

Embodiment 7. The method as recited in any preceding embodiment, wherein the workspace size prediction engine is trained based in part using historical workspace resource metrics data.

Embodiment 8. The method as recited in any preceding embodiment, wherein the workspace is provisioned, based on the one or more resources for provisioning the workspace, in a shared hybrid cloud platform.

Embodiment 9. A system, comprising hardware and/or software, operable to perform any of the operations, methods, or processes, or any portion of any of these, disclosed herein.

Embodiment 10. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

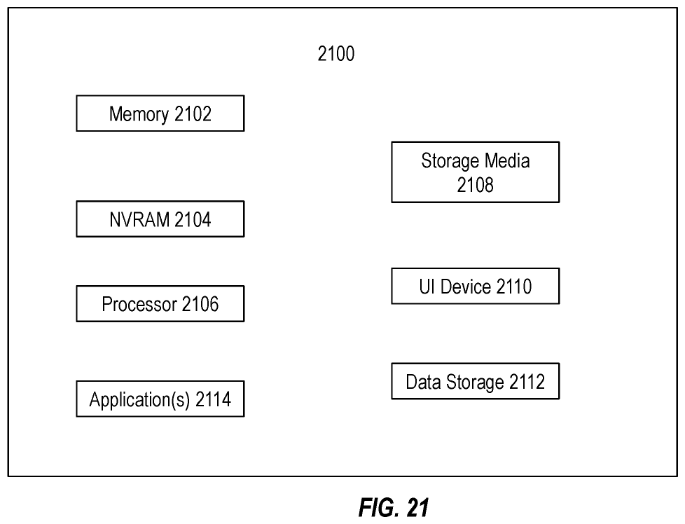

With reference briefly now to FIG. 21, any one or more of the entities disclosed, or implied, by FIGS. 1-20, and/or elsewhere herein, may take the form of, or include, or be implemented on, or hosted by, a physical computing device, one example of which is denoted at 2100. As well, where any of the aforementioned elements comprise or consist of a virtual machine (VM), that VM may constitute a virtualization of any combination of the physical components disclosed in FIG. 21.

In the example of FIG. 21, the physical computing device 2100 includes a memory 2102 which may include one, some, or all, of random access memory (RAM), non-volatile memory (NVM) 2104 such as NVRAM for example, read-only memory (ROM), and persistent memory, one or more hardware processors 2106, non-transitory storage media 2108, UI device 2110, and data storage 2112. One or more of the memory components 2102 of the physical computing device 2100 may take the form of solid state device (SSD) storage. As well, one or more applications 2114 may be provided that comprise instructions executable by one or more hardware processors 2106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a workspace size predicting engine, a workspace provisioning request including resource requirement information that specifies one or more features that are to be included when a workspace is provisioned, the one or more features including at least a machine learning (ML) model that is to be run in the workspace; and
predicting, by the workspace size predicting engine, one or more resources for provisioning the workspace that corresponds to the workspace provisioning request.

2. The method as recited in claim 1, wherein the one or more resources for provisioning the workspace comprise a number of containers, and a respective amount of memory and processing capability for each of the containers.

3. The method as recited in claim 1, wherein the workspace size prediction engine provides the one or more resources for provisioning the workspace to a workspace provisioning engine that provisions the workspace using the one or more resources for provisioning the workspace.

4. The method as recited in claim 1, wherein the workspace size prediction engine comprises a deep neural network (DNN)-based multi-output regressor that uses multi-target regression to predict the one or more resources for provisioning the workspace.

5. The method as recited in claim 4, wherein targets of the multi-target regression are a number of containers, and a respective amount of memory and processing capability for each of the containers.

6. The method as recited in claim 1, wherein the workspace size prediction engine is trained based in part using historical workspace resource metrics data.

7. The method as recited in claim 1, wherein the workspace size prediction engine is trained based in part using historical workspace resource metrics data.

8. The method as recited in claim 1, wherein the workspace is provisioned, based on the one or more resources for provisioning the workspace, in a shared hybrid cloud platform.

9. A non-transitory storage medium having stored therein instructions that are executable by one or more hardware processors to perform operations comprising:
receiving, by a workspace size predicting engine, a workspace provisioning request including resource requirement information that specifies one or more features that are to be included when a workspace is provisioned, the one or more features including at least a machine learning (ML) model that is to be run in the workspace; and
predicting, by the workspace size predicting engine, the one or more resources for provisioning the workspace that corresponds to the workspace provisioning request.

10. The non-transitory storage medium as recited in claim 9, wherein the one or more resources for provisioning the workspace comprises a number of containers, and a respective amount of memory and processing capability for each of the containers.

11. The non-transitory storage medium as recited in claim 9, wherein the workspace size prediction engine provides the one or more resources for provisioning the workspace to a workspace provisioning engine that provisions the workspace using the one or more resources for provisioning the workspace.

12. The non-transitory storage medium as recited in claim 9, wherein the workspace size prediction engine comprises a deep neural network (DNN)-based multi-output regressor that uses multi-target regression to predict the one or more resources for provisioning the workspace.

13. The non-transitory storage medium as recited in claim 12, wherein targets of the multi-target regression are a number of containers, and a respective amount of memory and processing capability for each of the containers.

14. The non-transitory storage medium as recited in claim 9, wherein the workspace size prediction engine is trained based in part using historical workspace resource metrics data.

15. The non-transitory storage medium as recited in claim 9, wherein the one or more features further include one or more of a size of a training dataset for the ML model run in the workspace, a number of users working on the workspace, and a type of use of the workspace.

16. The non-transitory storage medium as recited in claim 9, wherein the workspace is provisioned, based on the one or more resources for provisioning the workspace, in a shared hybrid cloud platform.

17. A computing system comprising:
one or more processors; and
one or more computer-readable hardware storage devices having stored thereon computer-executable instructions that are structured such that, when executed by the one or more processors, the computer-executable instructions cause the computing system to perform at least:
receiving, by a workspace size predicting engine, a workspace provisioning request including resource requirement information that specifies one or more features that are to be included when a workspace is provisioned, the one or more features including at least a machine learning (ML) model that is to be run in the workspace; and
predicting, by the workspace size predicting engine, the one or more resources for provisioning the workspace that corresponds to the workspace provisioning request.

18. The computing system as recited in claim 17, wherein the one or more resources for provisioning the workspace comprises a number of containers, and a respective amount of memory and processing capability for each of the containers.

19. The computing system as recited in claim 17, wherein the workspace size prediction engine provides the one or more resources for provisioning the workspace to a workspace provisioning engine that provisions the workspace using the one or more resources for provisioning the workspace.

20. The computing system as recited in claim 17, wherein the workspace size prediction engine comprises a deep neural network (DNN)-based multi-output regressor that uses multi-target regression to predict the one or more resources for provisioning the workspace.
